(19) United States
(12) Patent Application Publication
(10) Pub. No.: US 2022/0003862 A1
(43) Pub. Date: Jan. 6, 2022

(54) METHOD FOR A DETECTION AND CLASSIFICATION OF GESTURES USING A RADAR SYSTEM

(71) Applicant: HELLA GmbH & Co. KGaA, Lippstadt (DE)

(72) Inventors: Tai FEI, Hamm (DE); Yuliang SUN, Boeblingen (DE)

(73) Assignee: HELLA GmbH & Co. KGaA, Lippstadt (DE)

(21) Appl. No.: 17/478,190

(22) Filed: Sep. 17, 2021

Related U.S. Application Data
(63) Continuation of application No. PCT/EP2019/056820, filed on Mar. 19, 2019.

(51) Int. Cl. G01S 13/88; G06K 9/00; G06N 3/02; H01Q 1/32

(52) U.S. Cl. CPC G01S 13/88; H01Q 1/3291; G06N 3/02; G06K 9/00335

(57) ABSTRACT

A method for a detection and classification of gestures using a radar system, particularly of a vehicle. A detection information of the radar system is provided, wherein the detection information is specific for signals received from different antenna units of an antenna array of the radar system. At least one phase-difference information is determined from the detection information, wherein the phase-difference information is specific for a phase-difference of the received signals. A neural network is applied with the phase-difference information as an input for the neural network to obtain a result specific for the detection and classification of the gestures.

This nonprovisional application is a continuation of International Application No. PCT/EP2019/056820, which was filed on Mar. 19, 2019, and which is herein incorporated by reference.

### BACKGROUND OF THE INVENTION

### Field of the Invention

The present invention relates to a method for a detection and classification of gestures using a radar system. Furthermore, the invention relates to a radar system and a computer program.

### Description of the Background Art

It is known from the state of the art that neural networks can be used for a gesture detection based on radar signals. This makes it possible to classify different gestures, like hand gestures, by using a radar system. However, the usage of neural networks in this regard is still technologically complex and limited. For example, the reliability of the classification can be insufficient. Furthermore, it is often necessary to perform a manual clipping of the data streams received from the radar system to separate multiple gestures. In other words, conventional methods are not able to automatically detect and classify multiple gestures within these data streams. It must therefore be ensured that only one single gesture is present in the clipped time slot used as input for the neural network, which requires higher effort and cannot be part of an automated method.

Generic methods are known from DE 11 2015 003 655 T5 (which corresponds to US 2016/0041617), DE 10 2016 216 250 A1, DE 10 2016 213 667 A1 and DE 10 2016 120 507 A1 (which corresponds to US 2017/0124407).

### SUMMARY OF THE INVENTION

It is therefore an object of the present invention to provide a method for a detection and classification of gestures using a radar system.

According to an aspect of the invention, a method for a detection and classification of gestures using a radar system is provided. The radar system can particularly be part of a vehicle, preferably of a motor vehicle and/or a passenger car.

According to the method, the following steps can be carried out, particularly one after the other in the following order or in any order, wherein single steps can also be repeated: Providing a detection information of the radar system, wherein the detection information is specific for signals received from different antenna units of an antenna array of the radar system, wherein particularly the signals contain information about at least one gesture or multiple gestures, wherein preferably the gesture or these gestures are performed by a user (e.g. of the vehicle) in an environment of the radar system; Determining at least one phase-difference information from the detection information, wherein the phase-difference information is specific for a phase-difference of the received signals, particularly between signals received from different antenna units; and/or Applying a neural network with the phase-difference information as an input for the neural network to obtain a result (as an output of the neural network) specific for the detection and classification of the gestures.

This has the advantage that, by using the phase-difference information as an input for the neural network, the performance of the detection and/or the classification accuracy can be enhanced. This also results in a higher reliability of the gesture classification.

The steps of the method according to the invention can be carried out fully automatically, particularly without the necessity to manually detect and clip the detection information (for example in the form of data streams) according to each gesture as an intermediate step.

It is possible, that before using the above-mentioned method steps, a training of the neural network is performed. The input used for the step of applying the neural network can also be used as an input for the training. The training can be based on unsupervised learning or supervised learning, so as to teach the neural network to detect and classify the gestures based on the input.

Advantageously, the detection information can be determined by using the signals received from the different antenna units. For example, the radar system can adopt a linear chirp sequence frequency modulation to design a waveform. After mixing, filtering and sampling each one of these received signals, a respective discrete beat signal can be formed of reflecting points of objects in the environment for different measurement-cycles from one of the antenna units, particularly receiver antennas. To calculate the phase differences of the received signals, the spatial difference between two receiver antennas in elevation and azimuth directions can be considered, which can be λ/2, where λ is the wavelength used with the radar system. The received signal, in particular the beat signal, can be further processed to obtain at least one spectrogram from the signal. For example, a 2-dimensional finite Fourier transform can be applied on the received signal (particularly beat signal), preferably for each measurement-cycle, such that a time-varying velocity information can be observed. As a result of the Fourier transform applied for each measurement-cycle, a 3-D range-Doppler-measurement-cycle array can be obtained. A spectrogram, which particularly represents the μD signatures, can be deduced by integrating the resulting 3-D range-Doppler-measurement-cycle array over range. Using two receiver antennas that have a spatial difference of λ/2, the direction angle of an object could be estimated via the phase difference based on the monopulse angle estimation principle (see S. Sharenson, “Angle estimation accuracy with a monopulse radar in the search mode,” IRE Trans. Aerosp. Navig. Electron, Vol. ANE-9, No. 3, pp. 175-179, September 1962), which is incorporated herein by reference. For gesture recognition, i.e. detection and classification, the phase-difference information can be directly utilized as a function of the measurement-cycle, which contains the information of the direction angle of gestures.

It is conceivable that the radar system is used as a human-computer interface, particularly for a vehicle. Therefore, the radar system can be configured to recognize the gestures, like human hand gesture. This has the advantage that, unlike optical gesture recognition systems, radar sensors are insensitive to the ambient light conditions. Further, the electromagnetic waves used for the detection of the radar system can penetrate dielectric materials, which allows the radar system to be embedded into a device.

The radar system can be intended to be used for in-vehicle infotainment and/or a driver monitoring system of a vehicle.

Advantageously, the detection information can be specific for at least one (or multiple) gesture(s) performed in an environment of the radar system, particularly in an environment of the antenna array. This environment can e.g. be an interior space of the vehicle, so that the gesture is performed by a vehicle occupant.

Furthermore, it can be possible that the neural network is configured as a region-based deep convolutional neural network (R-DCNN). Such an R-DCNN is exemplary disclosed by S. Ren, K. He, R. Girshick, and J. Sun, “Faster R-CNN: Towards real-time object detection with region proposal networks,” IEEE Trans. Pattern Anal. Mach. Intell., Vol. 39, No. 6, pp. 1137-1149, June. 2017, which is incorporated herein by reference. A further disclosure related to R-DCNN can be found in V. Sze, Y. Chen, T. Yang, and J. S. Emer, “Efficient processing of deep neural networks: A tutorial and survey,” Proceedings of the IEEE, vol. 105, No. 12, pp. 2295-2329, December 2017 and R. Girshick, “Fast R-CNN,” in Proceedings IEEE Int. Conf. Comput. Vision, Santiago, Chile, December 2015, which is incorporated herein by reference. The R-DCNN is capable of automatically detecting and classifying gestures from the input. Furthermore, it turned out, that the R-DCNN can automatically distinguish different (multiple) gestures within the detection information. Therefore, a manual selection of the gestures contained in the detection information prior to the step of applying the neural network can be avoided. The input can comprise multiple gestures that are not explicitly distinguished.

It is also conceivable that the detection information is specific for a micro-Doppler signature of the gestures. It is therefore also possible that the radar system, for obtaining the detection information, uses a Doppler frequency modulation, which is called the micro-Doppler (μD) effect (see e.g.: V. C. Chen, F. Li, S. Ho, and H. Wechsler, “Micro-Doppler effect in radar: phenomenon, model, and simulation study,” IEEE Trans. Aerosp. Electron. Syst., Vol. 42, no. 1, pp. 2-21, January 2006), which is incorporated herein by reference. This makes it possible to extract μD features from the detection information, particularly from spectrograms determined by the detection information. These μD features can be understood as the micro-Doppler signature of the gestures. In other words, the micro-Doppler signature is the result of the Doppler frequency modulation.

It can be provided that at least one spectrogram is determined from the detection information and used as the input, in addition to the phase-difference information, for the neural network. In other words, the input comprises the spectrogram and the phase-difference information and is fed into the neural network. Accordingly, it is possible that the input of the neural network contains three channels, i.e., one spectrogram and two phase-difference channels. This can further enhance the classification efficiency.

Preferably, it can be provided that the input may be specific for multiple gestures, and the neural network is used (and particularly suitable) to distinguish between these multiple gestures, so that the result is specific for a detection of individual of the multiple gestures and a classification of these individual gestures. This can have the advantage that multiple gestures can be automatically detected and classified without manually clipping the detection information (e.g. in the form of data streams) according to each gesture in advance. The gestures can particularly be movements of a body part, preferably hand movement, of a person, or the like.

Advantageously, the detection information is determined by signals received from a first and second antenna unit of the antenna array specific for an elevation angle, and by signals received from a third and fourth antenna unit of the antenna array specific for an azimuth angle.

The antenna units of the antenna array can be positioned and/or attached with a predetermined distance from each other on an antenna array platform. The distance can e.g. be λ/2, wherein λ is the wavelength used with the radar system. This allows to calculate the phase-difference information from the received signals of the antenna units by comparing the different signals of the antenna units with each other. Furthermore, this allows to calculate the elevation angle and azimuth angle depending on the arrangement of the antenna units on the antenna array platform.

According to another aspect of the invention, a radar system comprises an antenna array for a detection in an environment of the antenna array, and a data processing apparatus.

It is possible that the data processing apparatus comprises: a detector for providing a detection information of the radar system, wherein the detection information is specific for signals received from different antenna units (e.g. single antennas) of the antenna array, a determinator for determining at least one phase-difference information from the detection information, wherein the phase-difference information is specific for a phase-difference of the received signals, an applicator for applying a neural network with the phase-difference information as an input for the neural network to obtain a result specific for the detection and classification of the gestures.

The determinator, applicator and detector can be configured as a part of an electronic device (hardware) of the radar system, like a processor or parts of the processor, or as a software part of the radar system. If configured as a software part, these can e.g. be a part of a computer program according to the invention, which can be read out by a processor from a data storage of the radar system in order to carry out the steps of a method according to the invention.

The data processing apparatus can be suitable for carrying out the method steps of a method according to the invention. Therefore, a radar system according to the invention can have the same advantages as described in the context of a method according to the invention.

It is possible that the antenna array is configured as an L-shaped antenna array. That means that the single antenna units can be arranged geometrically in an L-form on an antenna array platform. This allows to calculate the elevation angle and azimuth angle from the detection information. Particularly, for this calculation, the spatial difference between at least two antenna units is known, and is e.g. a half of the wavelength used for detection of the radar system.

It is also possible that the radar system is configured as a frequency-modulated continuous wave radar system (FMCW). For example, the radar system can be configured as a 77 GHz FMCW radar. This allows for an effective recognition of gestures.

According to another aspect of the invention, a computer program, particularly a computer program product, comprises instructions which, when the program is executed by a computer, cause the computer to carry out the following steps, and/or the steps of a method according to the invention: Providing a detection information of a radar system, wherein the detection information is specific for signals received from different antenna units of an antenna array of the radar system; Determining at least one phase-difference information from the detection information, wherein the phase-difference information is specific for a phase-difference of the received signals; and/or Applying a neural network with the phase-difference information as an input for the neural network to obtain a result specific for a detection and classification of gestures.

Therefore, the computer program according to the invention has the same advantages as described in the context of a method according to the invention. The computer program can be configured non-volatile and e.g. stored in a data storage of the computer. Furthermore, the computer can comprise a processor configured to read out the computer program from the data storage, in order to carry out the method steps.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic visualisation of a method according to the invention,

FIG. 2 shows a further schematic visualisation of a method according to the invention,

FIG. 3 shows a further schematic visualisation of a method according to the invention, and

FIG. 4 shows a schematic visualisation of a radar system according to the invention.

### DETAILED DESCRIPTION

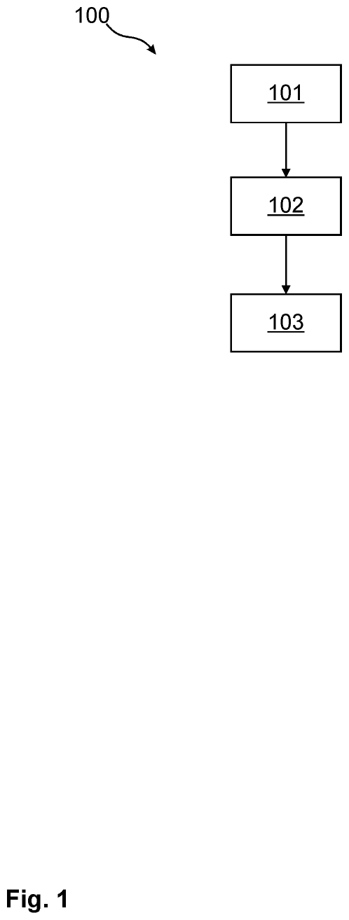

In FIG. 1, a method 100 for a detection and classification of gestures using a radar system 1 is visualized. According to a first method step 101, a detection information 200 of the radar system 1 is provided, wherein the detection information 200 is specific for signals received from different antenna units 11, 12, 13, 14 of an antenna array 10 of the radar system 1. According to a second method step 102, at least one phase-difference information 210 from the detection information 200 is determined, wherein the phase-difference information 210 is specific for a phase-difference of the received signals. According to a third method step 103, a neural network 220 is applied with the phase-difference information 210 as an input 221 for the neural network 220 to obtain a result 222 specific for the detection and classification of the gestures.

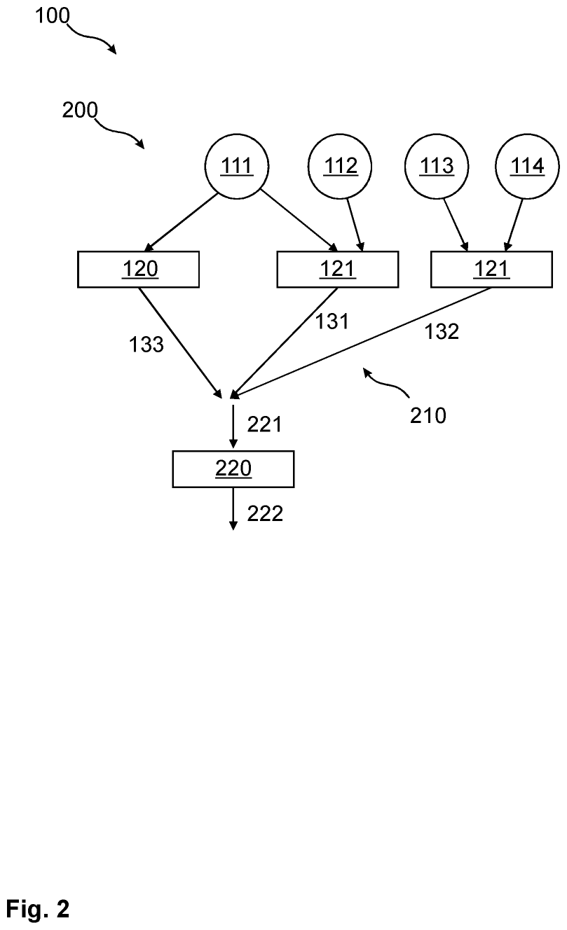

FIG. 2 shows further details how to exemplarily generate an input 221 for the neural network 220. A first radar signal 111 can be obtained from the signal received from a first antenna unit 11 of the antenna array 10. A second radar signal 112 can be obtained from the signal received from a second antenna unit 12 of the antenna array 10. A third radar signal 113 can be obtained from the signal received from a third antenna unit 13 of the antenna array 10. A fourth radar signal 114 can be obtained from the signal received from a fourth antenna unit 14 of the antenna array 10.

Then, the first radar signal 111 can be used for a time-frequency analysis 120 so as to obtain a time-frequency spectrum 133 (spectrogram). The first radar signal 111 and the second radar signal 112 can be used to calculate a first phase-difference information 131 by using a calculation 121. The third and fourth radar signal 113, 114 can be used to calculate a second phase-difference information 132 by using the calculation 121. The first and second phase-difference information 131, 132 together with the spectrogram 133 can form the input 221 for the neural network 220.

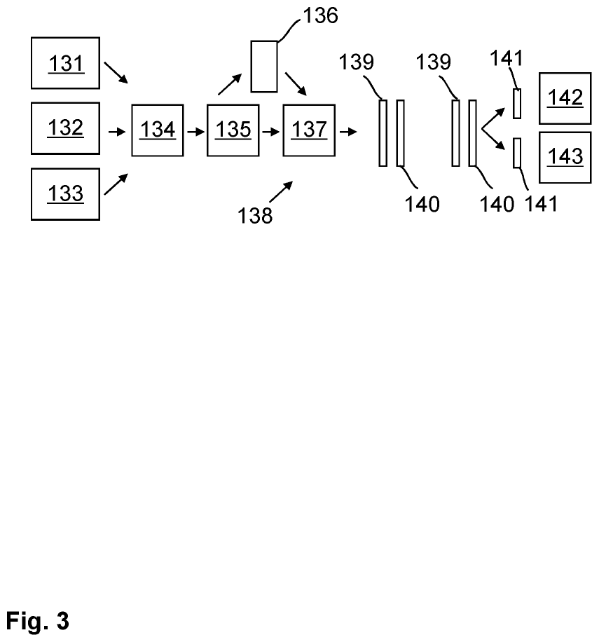

According to FIG. 3, an exemplarily processing for determining the input 221 for the neural network 220 is described. For generating the input 221 of the neural network 220, a feature extraction network (FEN) can optionally be used. To extract features from the spectrogram 133 and the phase-difference information 131, 132, the FEN 134 can be constructed by using 7 convolutional (Conv) layers, and each of them may have a kernel size of 3×3. The kernel number of the first four Conv layers can increase from 64, 128, 256 to 512, and that of Conv layer 5, 6, and 7 can be 512. In each Conv layer, a rectified linear unit (RELU) can be used as the activation function. Besides, Conv layer 1, 2, 3 and 5 are followed by max-pooling layers with kernel size 2×2. The output of the FEN 134 is the feature maps 135. The feature maps 135 can have a dimension of W×H×512. In each pixel of the feature maps 135, nine anchors using 3 scales of 8×8, 16×16, 32×32 and 3 aspect ratios of 1:2, 1:1, 2:1 can be generated. Then, among total 9W H possible anchors, the network could give several region proposals, i.e., Regions of Interest (RoIs), which are further processed by the following layers in the network. Using the region proposals acquired by a region proposal network (RPN 136), the relevant RoIs in feature maps 135 can be selected as input of the RoI pooling layer 138 (designated as feature maps with ROI 137). For each RoI, the feature maps 135 can be cropped and then max-pooled to fixed-size feature maps 135 because of size constraint in the following fully-connected (FC) layer. Each pooled RoI can then be fed into two FC layers 139, either of which has 4096 hidden units and followed by a dropout layer 140 for preventing the network from overfitting. For each RoI, the network gives two outputs using two separate output layers 141. The output layer 141 followed by a softmax function 142 gives the predicted class, and the other gives four values, which encode the bounding box position 143 of the predicted class.

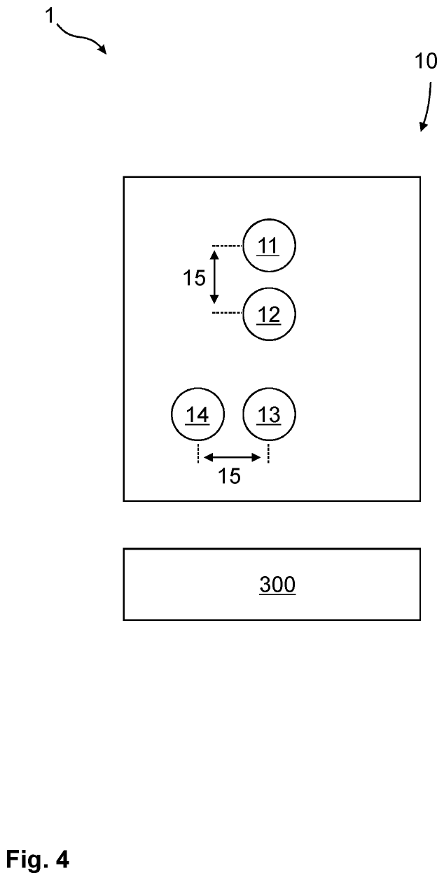

In FIG. 4, an exemplarily antenna array 10 with an L-form (i.e. an L-shaped antenna array) is shown. The antenna array 10 can comprise four antenna units, for example each configured as receiving antenna of the radar system 1. A first antenna unit 11 can be arranged with a distance 15 from a second antenna unit 12. A third antenna unit 13 can be arranged with a distance 15 from a fourth antenna unit 14. The distance 15 is for example λ/2, where A is the wavelength used with the radar system. This allows to use the pair of the first and second antenna unit 11, 12 for a calculation of the elevation angle, and the pair of the third and fourth antenna unit 13, 14 for a calculation of the azimuth angle. Furthermore, a data processing apparatus 300 of the radar system 1 is shown, which may perform this calculation.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for a detection and classification of gestures using a radar system of a vehicle, the method comprising:
providing a detection information of the radar system, the detection information being specific for signals received from different antenna units of an antenna array of the radar system;
determining at least one phase-difference information from the detection information, the phase-difference information being specific for a phase-difference of the received signals; and
applying a neural network with the phase-difference information as an input for the neural network to obtain a result specific for the detection and classification of the gestures.

2. The method according to claim 1, wherein the neural network is configured as a region-based deep convolutional neural network.

3. The method according to claim 1, wherein the detection information is specific for a micro-Doppler signature of the gestures.

4. The method according to claim 1, wherein at least one spectrogram is determined from the detection information and used as the input in addition to the phase-difference information for the neural network.

5. The method according to claim 1, wherein the input is specific for multiple gestures, and the neural network is used to distinguish between these multiple gestures, so that the result is specific for a detection of individual of the multiple gestures and a classification of these individual gestures.

6. The method according to claim 1, wherein the detection information is determined by signals received from a first and second antenna unit of the antenna array specific for an elevation angle and by signals received from a third and fourth antenna unit of the antenna array specific for an azimuth angle.

7. A radar system comprising:
an antenna array for a detection in an environment of the antenna array; and
a data processing apparatus comprising:
a detector to provide a detection information of the radar system, the detection information being specific for signals received from different antenna units of the antenna array;
a determinator to determine at least one phase-difference information from the detection information, the phase-difference information being specific for a phase-difference of the received signals; and
an applicator to apply a neural network with the phase-difference information as an input for the neural network to obtain a result specific for the detection and classification of the gestures.

8. The radar system according to claim 7, wherein the antenna array is configured as an L-shaped antenna array.

9. The radar system according to claim 7, wherein the radar system is configured as a frequency-modulated continuous wave radar system.

10. The radar system according to claim 7, wherein the data processing apparatus is adapted to perform the method comprising:
providing a detection information of the radar system, the detection information being specific for signals received from different antenna units of an antenna array of the radar system;
determining at least one phase-difference information from the detection information, the phase-difference information being specific for a phase-difference of the received signals; and
applying a neural network with the phase-difference information as an input for the neural network to obtain a result specific for the detection and classification of the gestures.
